(19) United States
(12) Patent Application Publication
(10) Pub. No.: US 2009/0097669 A1
(43) Pub. Date: Apr. 16, 2009

(54) Acoustic system for providing individual acoustic environment

(75) Inventor: Masahiro Kamiya, Kobe (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 12/285,522

(22) Filed: Oct. 8, 2008

(30) Foreign Application Priority Data
Oct. 11, 2007 (JP) 2007-265865
Oct. 11, 2007 (JP) 2007-265866

(51) Int. Cl. G10K 11/16

(52) U.S. Cl. 381/71.4

(57) ABSTRACT

An acoustic system uses a self speaker installed to be at the back of a listener in a first individual space and an error microphone installed to be closer to the listener than the self speaker. A sound-leakage reduction filter generates control sound for negating sound leaked from another speaker installed in a second individual space to the first individual space, and provides the control signal to the self speaker. A virtual sound-source filter generates a virtual sound source, and a rear-sound-source inverse filter corrects rearward localization of a sound image toward the listener.

### CROSS-REFERENCE TO RELATED APPLICATIONS

The present application claims priority to and incorporates by reference the entire contents of Japanese priority documents 2007-265865 and 2007-265866 filed in Japan on Oct. 11, 2007.

### BACKGROUND OF THE INVENTION

1. Field of the Invention

The present invention relates to an acoustic system for providing an individual acoustic environment with respect to each individual space in a predetermined space, and, more particularly to an acoustic system that can effectively reduce sound leakage from other seats even if there is an environmental change or a change with time, and that can provide an individual acoustic environment with a realistic sense while not blocking visibility of a listener.

2. Description of the Related Art

An acoustic system for providing a different acoustic environment for each seat has been known in vehicles such as airplanes, trains, and cars. However, if a listener does not use a headset, leak sound or noise from other seats causes a problem. Therefore, to provide a comfortable individual acoustic environment, reduction of such noise is important.

For example, Japanese Patent Application Laid-open No. H5-61477 discloses a method of reducing noise by using an error microphone for obtaining noise to generate a control sound for negating the obtained noise. Further, as a method of reducing sound leakage from other seats, Filtered-XLMS (adaptive least mean square filter) that uses an output of an error microphone and an other-seat sound source as a reference signal has been known.

It is assumed here that an other-seat speaker is arranged on other seats and a self seat speaker and a self-seat error microphone are arranged on a self seat. When the Filtered-XLMS is used, a control sound for negating sound leakage is generated based on a leak sound transfer function from the other-seat speaker to the self seat and an error path transfer function between the self seat speaker and the self-seat error microphone. As such an error path transfer function, a function that is presumed in advance prior to provision of the acoustic system is generally used.

However, when the error path transfer function presumed in advance is used, there is a problem that, when a sound field environment is changed between the time of presumption and the time of control, reduction accuracy of the leak sound deteriorates. Specifically, there is a change in the sound field environment (an environmental change such as person's position, humidity, and temperature, and a change with time of the error microphone and the speaker), between the time of presumption of the error path transfer function and the time of control using such an error path transfer function. However, because the path transfer function used at the time of control is not for the sound field environment at the time of control, highly accurate sound-leakage reduction control cannot be performed.

Meanwhile, to improve the control efficiency of the sound-leakage reduction control, it is desired to install a speaker and an error microphone at a position close to ears of a listener. However, when an individual acoustic environment is provided in a car, the speaker and the error microphone need to be installed on a self seat due to a safety reason such as not blocking the visibility of a driver.

However, if the speaker is installed on the self seat, the listener hears the sound from the back, thereby causing a problem such that a sound image is localized at the back, and listening with a realistic sense becomes difficult.

Accordingly, in the case that a speaker is arranged at the back of a listener, it is an important issue how to realize an acoustic system that can effectively reduce sound leakage from other seats even if there is an environmental change or a change with time, and that can provide an individual acoustic environment with a realistic sense while not blocking visibility of a listener.

### SUMMARY OF THE INVENTION

It is an object of the present invention to at least partially solve the problems in the conventional technology.

According to the present invention, an acoustic system includes: a self speaker that is installed to be at back of a listener in a first individual space in a predetermined space; an error microphone that is installed to be closer to the listener than the self speaker; a sound-leakage reducing unit that generates control sound for negating sound leaked from an other speaker installed in a second individual space in the predetermined space to the first individual space based on a leak sound transfer function between the other speaker and the error microphone and an error path transfer function between the self speaker and the error microphone, and provides the control sound to the self speaker; a virtual sound-source unit that generates a virtual sound source to form a sound image in front of the listener; and a localization correcting unit that corrects rearward localization of the sound image closer to the listener, the sound image being formed by reproduction of the virtual sound source by the self speaker.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a configuration of an acoustic system according to a first embodiment;

FIG. 2 is a diagram of an individual acoustic environment in a car;

FIG. 3 is a diagram illustrating the effects of a virtual sound-source filter and a rear-sound-source inverse filter;

FIG. 4 is a diagram of a signal flow in the acoustic system according to the first embodiment;

FIG. 5 is a schematic diagram of a configuration of an acoustic system according to a second embodiment;

FIG. 6 is a diagram of a signal flow in the acoustic system according to the second embodiment; and

FIG. 7 is a schematic diagram of a configuration of an acoustic system according to a conventional technology.

### DETAILED DESCRIPTION

Exemplary embodiments of an acoustic system according to the present invention will be explained in detail below with reference to the accompanying drawings. While the acoustic system according to the present invention is explained below as being applied to a car, it can also be applied to seats in movie theaters, concert halls, trains, buses, and the like.

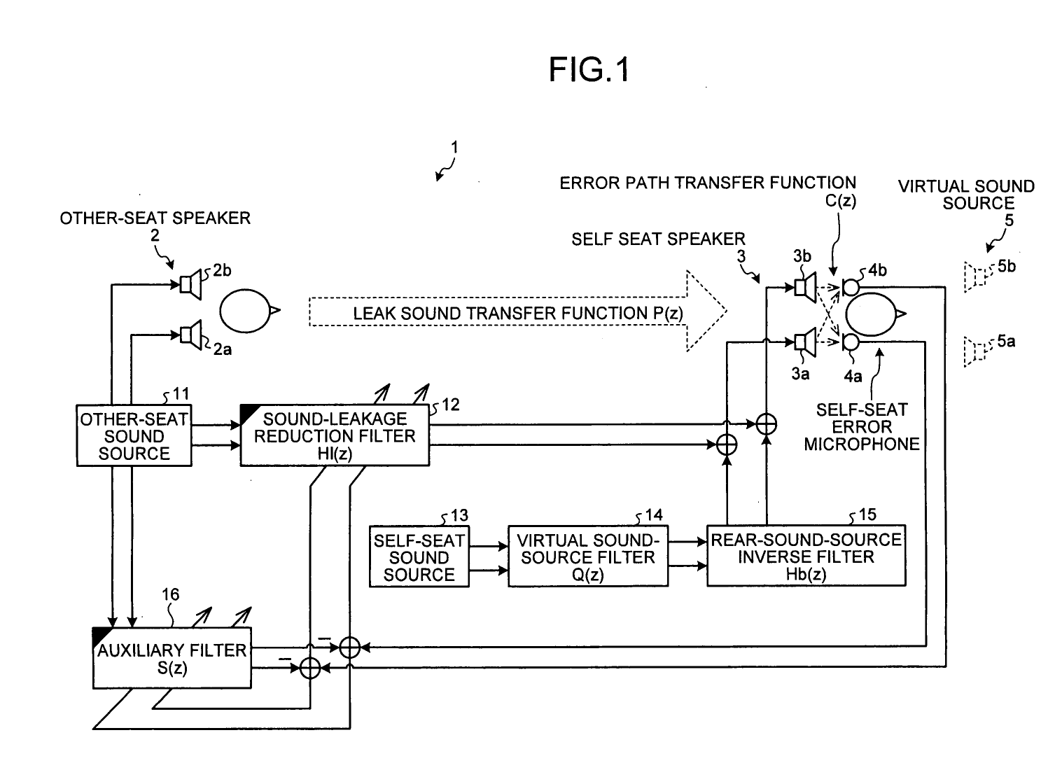

FIG. 1 is a schematic diagram of a configuration of an acoustic system according to a first embodiment. As illustrated in FIG. 1, an acoustic system 1 includes an other-seat speaker 2, a self seat speaker 3, a self-seat error microphone 4, an other-seat sound source 11, a sound-leakage reduction filter 12, a self-seat sound source 13, a virtual sound-source filter 14, a rear-sound-source inverse filter 15, and an auxiliary filter 16. The sound provided from the self seat speaker 3 has a virtual sound image in front of a listener on a self seat (see “virtual sound source 5” in FIG. 1). Filters indicated in black at an upper left corner (the sound-leakage reduction filter 12 and the auxiliary filter 16) express that these filters are ADFs (adaptive digital filters).

As illustrated in FIG. 1, the acoustic system 1 according to the first embodiment dynamically presumes a leak sound transfer function P(z) between the other-seat speaker 2 and the self-seat error microphone 4 and an error path transfer function C(z) between the self seat speaker 3 and the self-seat error microphone 4 (see “auxiliary filter 16” in FIG. 1) to effectively reduce the sound leaked from the other-seat speaker 2 to the listener on the self seat, and localizes the sound generated from the self seat speaker 3 in front of the listener as indicated by the virtual sound source 5 to provide an individual acoustic environment with a realistic sense.

Thus, by dynamically presuming the error path transfer function C(z) highly variable according to an environmental change, operation accuracy of the sound-leakage reduction filter 12 can be improved. Further, by generating a sound having a sound image in front of the listener by the virtual sound-source filter 14, and localizing the sound image with the position of the self seat speaker 3 being set as a reference at a position of the self-seat error microphone 4 near the ear position of the listener by the rear-sound-source inverse filter 15, the individual acoustic environment with a realistic sense can be provided.

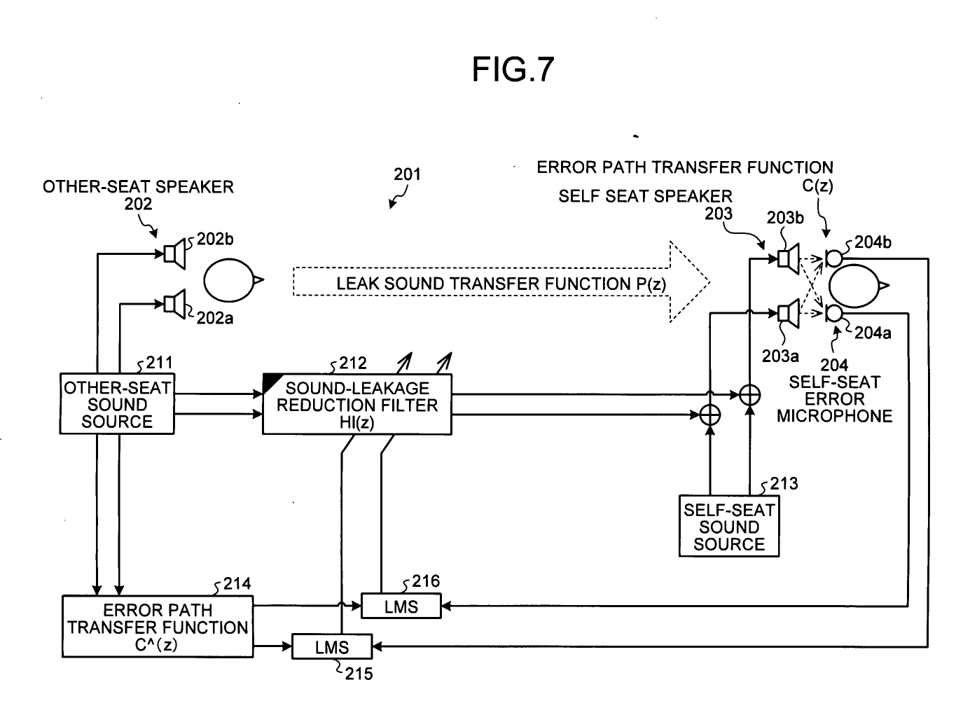

A conventional acoustic system is explained with reference to FIG. 7 from a viewpoint of clarifying a characteristic feature of the acoustic system 1 according to the first embodiment. FIG. 7 is a schematic diagram of a configuration of an acoustic system 201 according to the conventional technology.

As illustrated in FIG. 7, the acoustic system 201 according to the conventional technology includes an other-seat speaker 202, a self seat speaker 203, a self-seat error microphone 204, an other-seat sound source 211, a sound-leakage reduction filter 212, a self-seat sound source 213, an error path transfer function 214, an LMS (least mean square filter) 215 and an LMS 216. The LMS 215 and LMS 216 respectively correspond to left and right self-seat error microphones (204a and 204b), and a filter indicated in black at an upper left corner (the sound-leakage reduction filter 12) expresses that the filter is the ADF (adaptive digital filter).

As illustrated in FIG. 7, the transfer function between the other-seat speaker 202 and the self-seat error microphone 204 is defined as “leak sound transfer function P(z)” and a transfer function between the self seat speaker 203 and the self-seat error microphone 204 is defined as “error path transfer function C(z)”. An entity of the error path transfer function 214 is “error path transfer function Ĉ(z)”, in which the “error path transfer function C(z)” is presumed in advance.

That is, the acoustic system 201 according to the conventional technology adaptively controls the sound-leakage reduction filter 212 based on the “error path transfer function Ĉ(z)” presumed in advance and an output of the self-seat error microphone 204. The sound-leakage reduction filter 212 presumes the “leak sound transfer function P(z)” based on the static “error path transfer function Ĉ(z)”.

However, because the “error path transfer function C(z)” changes according to a sound field environment (environment such as person's position, humidity, and temperature, and environment with time of the error microphone and the speaker) at the time of control, the “error path transfer function C(z)” is separated from a static “error path transfer function Ĉ(z)”. Therefore, even if the sound-leakage reduction filter 212 is adaptively controlled by using the error path transfer function 214, with the “error path transfer function Ĉ(z)” being the entity, highly accurate reduction of sound leakage cannot be performed.

In the acoustic system 201 according to the conventional technology, because the self seat speaker 203 installed at the back of the listener on the self seat provides the acoustic environment to the listener on the self seat, the acoustic environment to be provided is localized at the back of the listener. Therefore, there is a problem that an acoustic environment with a realistic sense cannot be provided to the listener.

In the acoustic system 1 according to the first embodiment illustrated in FIG. 1, therefore, the sound-leakage reduction filter 12 is adaptively controlled by using the auxiliary filter 16 that dynamically presumes the “error path transfer function C(z)” and the “leak sound transfer function P(z)”, and the sound image is localized in front of the listener by using the virtual sound-source filter 14 and the rear-sound-source inverse filter 15.

Returning to the explanation of FIG. 1, the acoustic system 1 according to the first embodiment is explained in detail. The other-seat speaker 2 includes a right speaker 2a and a left speaker 2b, and is installed, for example, on a backside of a rear seat or the like in the car. The other-seat speaker 2 is connected to the other-seat sound source 11, and reproduces the individual acoustic environment such as music and voices for other seats.

The self seat speaker 3 includes a right speaker 3a and a left speaker 3b, and is installed, for example, on a backside of a driver's seat in the car. The self seat speaker 3 is connected to the sound-leakage reduction filter 12 and the rear-sound-source inverse filter 15, to reproduce the individual acoustic environment such as music or voices for the self seat, and reproduce a control sound for negating the leak sound from the other-seat speaker 2.

The self-seat error microphone 4 includes a right error microphone 4a and a left error microphone 4b respectively installed in front of the right speaker 3a and the left speaker 3b constituting the self seat speaker 3. The self-seat error microphone 4 is installed, for example, on the backside of the driver's seat in the car as in the case of the self seat speaker 3. An output of the self-seat error microphone 4 is used for presumption of the “error path transfer function C(z)” in the auxiliary filter 16.

The other-seat sound source 11 is a device that reproduces music or voices recorded on a portable recording medium such as a CD (compact disk) or a DVD (digital versatile disk), or music or voice from radio, television, car navigation system and the like. An output of the other-seat sound source 11 is input to the other-seat speaker 2 and also to the sound-leakage reduction filter 12 and the auxiliary filter 16.

The sound-leakage reduction filter 12 uses the leak sound transfer function P(z) and the error path transfer function C(z) presumed based on the output of the auxiliary filter 16, to generate a control sound for negating the leak sound from the other-seat speaker 2 on the front seat. The sound-leakage reduction filter 12 is configured as the ADF (adaptive digital filter).

A calculation procedure performed by the sound-leakage reduction filter 12 is briefly explained. When it is assumed that the sound-leakage reduction filter 12 is “H1(z)”, the auxiliary filter 16 is “S(z)”, the leak sound transfer function is “P(z)”, and error path transfer function is “C(z)”, relation between these is expressed by an equation “S(z)=P(z)+H1(z)C(z)”. The control sound (negating sound) generated by the sound-leakage reduction filter 12 is expressed as “H1(z)C(z)”.

In the equation “S(z)=P(z)+H1(z)C(z)”, by inputting two initial values (S1(z), H11(z), and S2(z), H12(z)) respectively to S(z) and H1(z), and updating S(z) and H1(z) so that a negating error becomes minimum, optimum P(z) and C(z) can be presumed. An optimum H1(z) is expressed by an equation “H1(z)=−P(z)/C(z)”.

The self-seat sound source 13 is a device that reproduces music or voice recorded on a portable recording medium such as a CD (compact disk) or a DVD (digital versatile disk), or music or voice from radio, television, car navigation system and the like. An output of the self-seat sound source 13 is output to the self seat speaker 3 via the virtual sound-source filter 14 and the rear-sound-source inverse filter 15.

The virtual sound-source filter 14 is a filter (Q(z)) that receives the output from the self-seat sound source 13 to generate a virtual sound field having a virtual sound image in front of the listener on the self seat. The virtual sound field generated by the virtual sound-source filter 14 is obtained, as indicated by the virtual sound source 5 in FIG. 1, by processing a signal from the self-seat sound source 13 as if there is a sound source in front of the listener. The virtual sound-source filter 14 can obtain a sound field with a realistic sense and without exerting a processing load, because the transfer function is obtained in advance based on a preliminary measurement result. The preliminary measurement is performed by generating a voice from two speakers installed in front of a dummy head imitating the listener, and measuring an impulse response at the ear position by a microphone installed at the ear position of the dummy head. A target transfer function related to a target sound field is obtained based on the measurement result, and the obtained target transfer function is designated as Q(z).

The rear-sound-source inverse filter 15 is a filter defined as an inverse function of the error path transfer function C(z) between the self seat speaker 3 and the self-seat error microphone 4, and performs a process of localizing the virtual sound field based on the position of the self seat speaker 3 at a position of the self-seat error microphone 4. Accordingly, rearward localization of the sound image resulting from installation of the self seat speaker 3 at the back of the listener can be corrected. When the rear-sound-source inverse filter 15 is designated as “Hb(z)”, Hb(z) is expressed by an equation “Hb(z)=1/C(z)”. As C(z) in this equation, a static error path transfer function presumed in advance is used.

The auxiliary filter 16 receives the outputs from the other-seat sound source 11 and the self-seat error microphone 4, and performs a process of presuming the leak sound transfer function P(z) and the error path transfer function C(z). An output of the auxiliary filter 16 is used for adaptive control of the sound-leakage reduction filter 12.

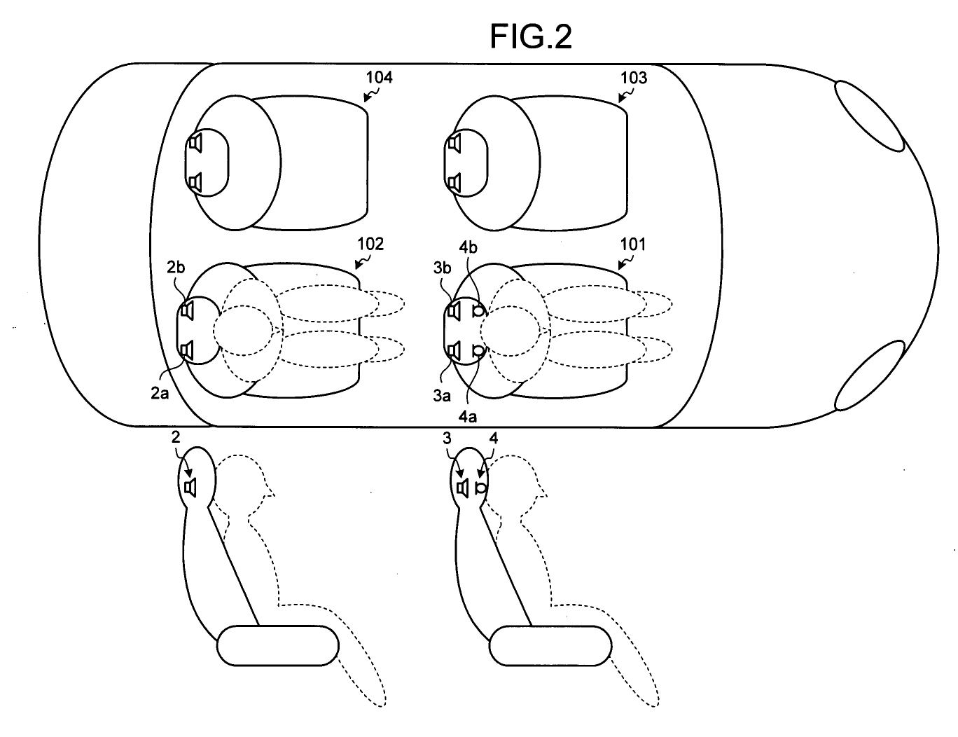

A positional relation of the other-seat speaker 2, the self seat speaker 3, and the self-seat error microphone 4 explained with reference to FIG. 1 is explained with reference to FIG. 2. FIG. 2 depicts an individual acoustic environment in the car. As illustrated in FIG. 2, the speaker is installed in each seat in the car, to provide the acoustic environment different from each other, that is, an individual acoustic environment to each individual space corresponding to each seat. FIG. 2 depicts a case that a driver's seat 101 is designated as the “self seat”, and a rear seat at the back of the driver's seat is designated as the “other seat”, and the individual acoustic environment provided for the driver's seat 101 is improved.

As illustrated in FIG. 2, the self seat speaker 3 including the right speaker 3a and the left speaker 3b is installed toward the listener near the head of the listener on the self seat (driver's seat) 101. The self-seat error microphone 4 including the right error microphone 4a and the left error microphone 4b is further installed in front of the self seat speaker 3 (at a position on the listener's side on the seat).

Further, the other-seat speaker 2 including the right speaker 2a and the left speaker 2b is installed toward the listener near the head of the listener on a rear seat 102 at the back of the driver's seat. In FIG. 2, a case is illustrated that the driver's seat 101 is designated as the “self seat”, and the rear seat 102 at the back of the driver's seat is designated as the “other seat”. However, any of a passenger seat 103 and a rear seat 104 of the passenger seat can be designated as the “other seat”, or the “other seat” can be the respective seats (102 to 104) in combination. Further, the error microphone can be installed in each seat, thereby improving the individual acoustic environment provided to respective seats other than the driver's seat 101.

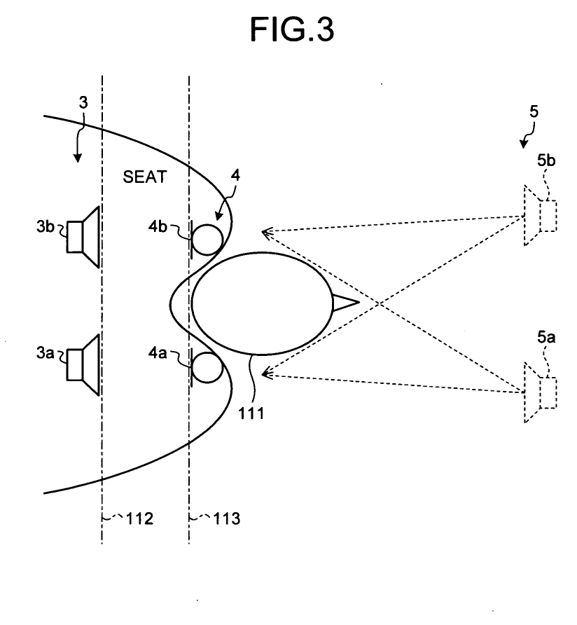

The effects of the virtual sound-source filter 14 and the rear-sound-source inverse filter 15 are explained next with reference to FIG. 3. FIG. 3 illustrates the effects of the virtual sound-source filter 14 and the rear-sound-source inverse filter 15. As illustrated in FIG. 3, the virtual sound source 5 generated by the virtual sound-source filter 14 includes a right virtual sound source 5a and a left virtual sound source 5b, and has a sound image as if the sound source is present in front of a listener 111. Therefore, an individual acoustic environment can be provided with a realistic sense compared with the case of using only the self-seat sound source 13.

However, although the virtual sound source 5 generated by the virtual sound-source filter 14 has a sound image in front of the listener 111, a reproduction reference position of the sound image is based on a reproduction position with the headset (that is, the ear position) in the case that the listener 111 uses the headset. However, the position of the self seat speaker 3 (see 112 in FIG. 3) is backward than the reproduction reference position. Therefore, the listener 111 has an impression such that the sound image is localized at the back (rearward localization sense).

The rear-sound-source inverse filter 15 is for correcting such a rearward localization sense, and corrects the reproduction reference position of the sound image from 112 in FIG. 3 to 113 in FIG. 3 (original reproduction reference position) to approach the ear position of the listener 111, thereby dissolving a disadvantage due to the installation of the self seat speaker 3 at the back of the listener 111.

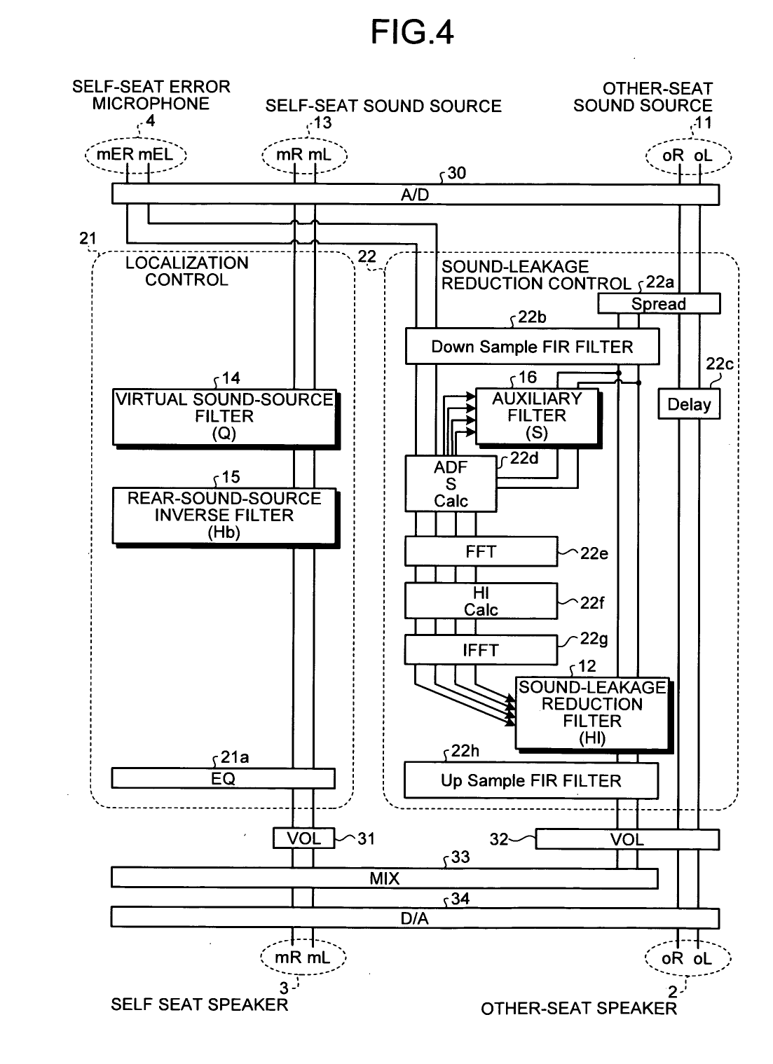

A signal flow in the acoustic system 1 according to the first embodiment is explained next with reference to FIG. 4. FIG. 4 depicts a signal flow in the acoustic system 1 according to the first embodiment. In FIG. 4, “A/D 30” stands for analog-to-digital converter, “Spread 22a” denotes signal distributor or duplicator, “EQ 21a” stands for equalizer, “FFT 22e” stands for Fast Fourier Transform, “IFFT 22g” stands for inverse Fast Fourier Transform, “VOL 31” and “VOL 32” denote volume, “MIX 33” stands for mixer, and “D/A 34” stands for a digital-to-analog converter.

Further, regarding a self-seat error microphone signal corresponding to the self-seat error microphone 4, a signal from the right error microphone 4a is described as “mER” and a signal from the left error microphone 4b is described as “mEL”. Regarding the self-seat sound source 13, the right signal is described as “mR” and the left signal is described as “mL”, and regarding the other-seat sound source 11, the right signal is described as “oR” and the left signal is described as “oL”. Regarding the output signal to the self seat speaker 3, a signal to the right speaker 3a is described as “mR” and a signal to the left speaker 3b is described as “mL”. Regarding the output signal to the other-seat speaker 2, a signal to the right speaker 2a is described as “oR” and a signal to the left speaker 2b is described as “oL”.

As illustrated in FIG. 4, control processing performed by the acoustic system 1 according to the first embodiment can be divided into a localization control 21 mainly performed by the virtual sound-source filter 14 and the rear-sound-source inverse filter 15, and a sound-leakage reduction control 22 mainly performed by the auxiliary filter 16 and the sound-leakage reduction filter 12.

A signal flow in the localization control 21 is explained first. The signals mR and mL corresponding to the self-seat sound source 13 are input to the virtual sound-source filter 14 via the A/D 30. The virtual sound-source filter 14 converts the signals mR and mL to signals corresponding to the virtual sound field having a virtual sound image in front of the listener on the self seat, and outputs the signals to the rear-sound-source inverse filter 15. The rear-sound-source inverse filter 15 performs a correction process of bringing the rearward localization of the sound image closer to the ear position of the listener.

The output of the rear-sound-source inverse filter 15 is input to the MIX 33 via the EQ 21a and the VOL 31. The MIX 33 synthesizes the signals mR and mL converted in the localization control 21 with the signals oR and oL converted in the sound-leakage reduction control 22 (control sound, which is a negating sound of the leak sound), and outputs the synthesized signals to the self seat speaker 3 via the D/A 33 as the signals mR and mL.

A signal flow in the sound-leakage reduction control 22 is explained next. The signals oR and oL corresponding to the other-seat sound source 11 are input to the Spread 22a via the A/D 30. The Spread 22a distributes the signals oR and oL to a Down Sample FIR filter 22b and a Delay 22c.

The Delay 22c having received the signals oR and oL distributed by the Spread 22a performs a predetermined delay process with respect to these signals, and outputs the signals to the other-seat speaker via the VOL 32 and the D/A 34 as the signals oR and oL.

Meanwhile, mER and mEL, which are self-seat error microphone signals via the A/D 30, are also input to the Down Sample FIR filter 22b having received the signals oR and oL distributed by the Spread 22a. The Down Sample FIR filter 22b performs resampling (down-sampling) by a sampling frequency lower than the sampling frequency of the input signal. The signal down-sampled by the Down Sample FIR filter 22b is up-sampled in an Up Sample FIR filter 22h and output. Thus, by using the down-sampling and the up-sampling together, the leak sound can be reduced highly accurately, as compared with a case that only a sound in a predetermined frequency range is reduced by using a low-pass filter or the like.

The signals oR and oL output from the Down Sample FIR filter 22b are input to the auxiliary filter 16 and the sound-leakage reduction filter 12. The signals oR and oL output from the auxiliary filter 16 are input to an ADF-S-Calc 22d together with the signals mER and mEL output from the Down Sample FIR filter 22b, thereby calculating a value S(z) of the auxiliary filter 16 in the ADF-S-Calc 22d.

A coefficient value group calculated by the ADF-S-Calc 22d is output to the sound-leakage reduction filter 12 via the FFT 22e, an H1 Calc 22f, and the IFFT 22g. The H1 Calc 22f calculates a value H1(z) of the sound-leakage reduction filter 12.

An output signal from the IFFT 22g and signals oR and oL from the Down Sample FIR filter 22b are input to the sound-leakage reduction filter 12. The control sound (negating sound of the leak sound) calculated by the sound-leakage reduction filter 12 is output to the MIX 33 via the Up Sample FIR filter 22h and the VOL 32, synthesized with the signals mR and mL converted in the localization control 21 by the MIX 33, and output to the self seat speaker 3 via the D/A 34 as the signals mR and mL.

As described above, according to the first embodiment, the acoustic system is configured such that the sound-leakage reduction filter generates a control sound for negating the sound leaked from the other speaker installed in a second individual space toward a first individual space based on the leak sound transfer function between the other speaker and the error microphone and the error path transfer function between the self speaker and the error microphone, by using the self speaker installed at the back of the listener in the first individual space and the error microphone installed closer to the listener than the self speaker, and provides the generated control sound to the self speaker. The virtual sound-source filter generates a virtual sound source, which is a sound provided by arranging a sound image in front of the listener, and the rear-sound-source inverse filter corrects the rearward localization of the sound image generated by reproduction of the virtual sound source by the self speaker closer to the listener.

Further, the acoustic system is configured such that the auxiliary filter is connected to the error microphone and the sound-leakage reduction filter so that the leak sound transfer function and the error path transfer function presumed dynamically are provided to the sound-leakage reduction filter.

Therefore, even if there is an environmental change and a change with time, leak sound from other seats can be effectively reduced, and an individual acoustic environment can be provided with a realistic sense while not blocking the visibility of the listener.

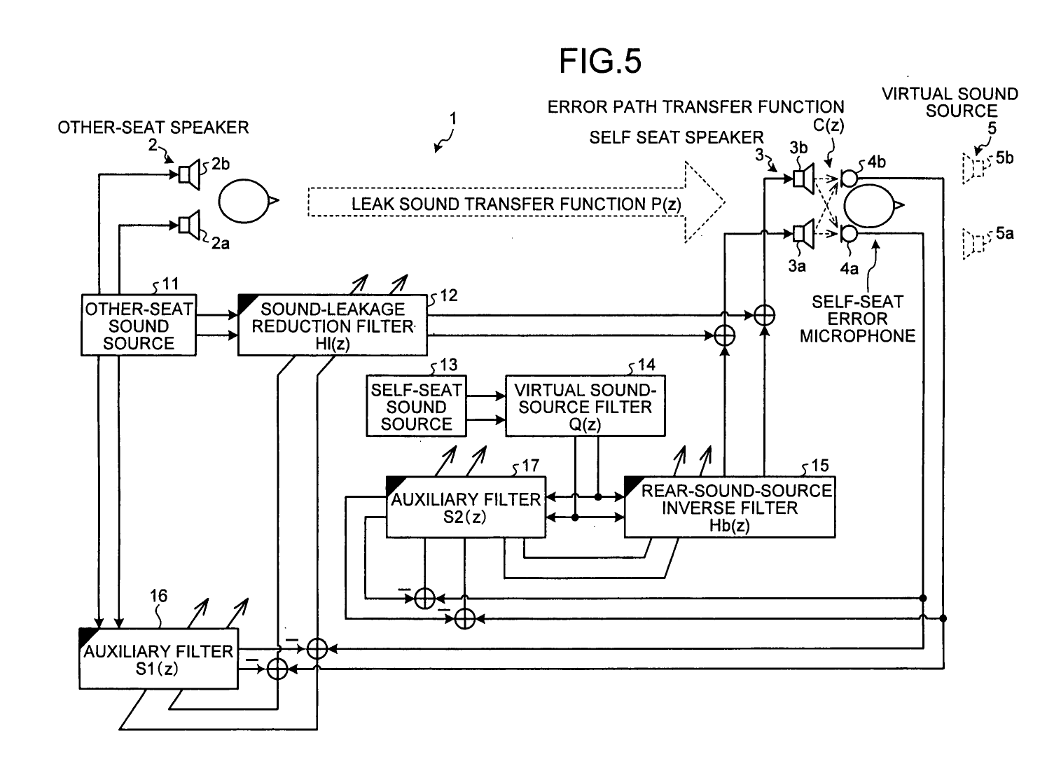

An acoustic system according to a second embodiment is explained next. FIG. 5 is a schematic diagram of a configuration of the acoustic system according to the second embodiment. As illustrated in FIG. 5, the acoustic system 1 includes the other-seat speaker 2, the self seat speaker 3, the self-seat error microphone 4, the other-seat sound source 11, the sound-leakage reduction filter 12, the self-seat sound source 13, the virtual sound-source filter 14, the rear-sound-source inverse filter 15, the auxiliary filter (first auxiliary filter) 16, and an auxiliary filter (second auxiliary filter) 17. The sound provided from the self seat speaker 3 has a virtual sound image in front of the listener on the self seat (see “virtual sound source 5” in FIG. 5). Filters indicated in black at an upper left corner (the sound-leakage reduction filter 12, the rear-sound-source inverse filter 15, the auxiliary filter (first auxiliary filter) 16, and the auxiliary filter (second auxiliary filter) 17) express that these filters are ADFs (adaptive digital filters).

As illustrated in FIG. 5, the acoustic system 1 according to the second embodiment dynamically presumes the leak sound transfer function P(z) between the other-seat speaker 2 and the self-seat error microphone 4 and the error path transfer function C(z) between the self seat speaker 3 and the self-seat error microphone 4 to effectively reduce the sound leaked from the other-seat speaker 2 to the listener on the self seat, and localizes the sound generated from the self seat speaker 3 in front of the listener as indicated by the virtual sound source 5, to provide an individual acoustic environment with a realistic sense.

Thus, by providing the leak sound transfer function P(z) and the error transfer function C(z) dynamically presumed by the auxiliary filter (first auxiliary filter) 16 to the sound-leakage reduction filter 12, and by providing the error transfer function C(z) dynamically presumed by the auxiliary filter (second auxiliary filter) 17 to the rear-sound-source inverse filter 15, the accuracy of the sound-leakage reduction filter 12 and the rear-sound-source inverse filter 15 can be improved.

Further, by generating a sound having a sound image in front of the listener by the virtual sound-source filter 14, and localizing the sound image with the position of the self seat speaker 3 being set as a reference at a position of the self-seat error microphone 4 near the ear position of the listener by the rear-sound-source inverse filter 15, an individual acoustic environment with a realistic sense can be provided.

As explained with reference to FIG. 7, the acoustic system 201 according to the conventional technology adaptively controls the sound-leakage reduction filter 212 based on the “error path transfer function Ĉ(z) presumed in advance and the output of the self-seat error microphone 204. The sound-leakage reduction filter 212 presumes the “leak sound transfer function P(z)” based on the static “error path transfer function Ĉ(z)”.

However, because the “error path transfer function C(z)” changes according to the sound field environment (environment such as person's position, humidity, and temperature, and environment with time of the error microphone and the speaker) at the time of control, the “error path transfer function C(z)” is separated from the static “error path transfer function Ĉ(z)”. Therefore, even if the sound-leakage reduction filter 212 is adaptively controlled by using the error path transfer function 214, with the “error path transfer function Ĉ(z)” being the entity, highly accurate reduction of sound leakage cannot be performed.

Further, in the acoustic system 201 according to the conventional technology, because the self seat speaker 203 installed at the back of the listener on the self seat provides the acoustic environment to the listener on the self seat, the acoustic environment to be provided is localized at the back of the listener. Therefore, there is a problem that the acoustic environment with a realistic sense cannot be provided to the listener.

In the acoustic system 1 according to the second embodiment illustrated in FIG. 5, therefore, the sound-leakage reduction filter 12 is adaptively controlled by using the auxiliary filter (first auxiliary filter) 16 that dynamically presumes the “error path transfer function C(z)” and the “leak sound transfer function P(z)”, and the rear-sound-source inverse filter 15 is adaptively controlled by using the auxiliary filter (second auxiliary filter) 17 that dynamically presumes the “error path transfer function C(z)”. The sound image is then localized in front of the listener by using the virtual sound-source filter 14 and the rear-sound-source inverse filter 15.

The acoustic system 1 according to the second embodiment is explained in detail. The other-seat speaker 2 includes the right speaker 2a and the left speaker 2b, and is installed, for example, on the backside of the rear seat or the like in the car. The other-seat speaker 2 is connected to the other-seat sound source 11, and reproduces the individual acoustic environment such as music and voices for other seats.

The self seat speaker 3 includes the right speaker 3a and the left speaker 3b, and is installed, for example, on the backside of the driver's seat in the car. The self seat speaker 3 is connected to the sound-leakage reduction filter 12 and the rear-sound-source inverse filter 15, to reproduce the individual acoustic environment such as music or voices for the self seat, and reproduce a control sound for negating the leak sound from the other-seat speaker 2.

The self-seat error microphone 4 includes the right error microphone 4a and the left error microphone 4b respectively installed in front of the right speaker 3a and the left speaker 3b constituting the self seat speaker 3. The self-seat error microphone 4 is installed, for example, on the backside of the driver's seat in the car as in the case of the self seat speaker 3. The output of the self-seat error microphone 4 is used for presumption of the respective transfer functions in the auxiliary filter (first auxiliary filter) 16 and the auxiliary filter (second auxiliary filter) 17.

The other-seat sound source 11 is a device that reproduces music or voices recorded on a portable recording medium such as a CD (compact disk) or a DVD (digital versatile disk), or music or voice from radio, television, car navigation system and the like. The output of the other-seat sound source 11 is input to the other-seat speaker 2 and also to the sound-leakage reduction filter 12 and the auxiliary filter (first auxiliary filter) 16.

The sound-leakage reduction filter 12 uses the leak sound transfer function P(z) and the error path transfer function C(z) presumed based on the output of the auxiliary filter (first auxiliary filter) 16, to generate the control sound for negating the leak sound from the other-seat speaker 2 on the front seat. The sound-leakage reduction filter 12 is configured as the ADF (adaptive digital filter).

The calculation procedure performed by the sound-leakage reduction filter 12 is briefly explained. When it is assumed that the sound-leakage reduction filter 12 is “H1(z)”, the auxiliary filter 16 is “S(z)”, the leak sound transfer function is “P(z)”, and the error path transfer function is “C(z)”, the relation between these is expressed by the equation “S(z)=P(z)+H1(z)C(z)”. The control sound (negating sound) generated by the sound-leakage reduction filter 12 is expressed as “H1(z)C(z)”.

In the equation “S(z)=P(z)+H1(z)C(z)”, by inputting two initial values (S1(z), H11(z), and S2(z), H12(z)) respectively to S(z) and H1(z), and updating S(z) and H1(z) so that the negating error becomes minimum, optimum P(z) and C(z) can be presumed. The optimum H1(z) is expressed by the equation “H1(z)=−P(z)/C(z)”.

The self-seat sound source 13 is a device that reproduces music or voice recorded on a portable recording medium such as a CD (compact disk) or a DVD (digital versatile disk), or music or voice from radio, television, car navigation system and the like. The output of the self-seat sound source 13 is output to the self seat speaker 3 via the virtual sound-source filter 14 and the rear-sound-source inverse filter 15.

The virtual sound-source filter 14 is a filter (Q(z)) that receives the output from the self-seat sound source 13 to generate the virtual sound field having the virtual sound image in front of the listener on the self seat. The virtual sound field generated by the virtual sound-source filter 14 is obtained, as indicated by the virtual sound source 5 in FIG. 1, by processing a signal from the self-seat sound source 13 as if there is a sound source in front of the listener. The virtual sound-source filter 14 can obtain a sound field with a realistic sense and without exerting a processing load, because the transfer function is obtained in advance based on a preliminary measurement result. The preliminary measurement is performed by generating a voice from two speakers installed in front of a dummy head imitating the listener, and measuring an impulse response at the ear position by the microphone installed at the ear position of the dummy head. The target transfer function related to the target sound field is obtained based on the measurement result, and the obtained target transfer function is designated as Q(z).

The rear-sound-source inverse filter 15 is a filter corresponding to the inverse function of the error path transfer function C(z) between the self seat speaker 3 and the self-seat error microphone 4, and performs a process of localizing the virtual sound field based on the position of the self seat speaker 3 at a position of the self-seat error microphone 4. Accordingly, rearward localization of the sound image resulting from installation of the self seat speaker 3 at the back of the listener can be corrected. When the rear-sound-source inverse filter 15 is designated as “Hb(z)”, Hb(z) is expressed by the equation “Hb(z)=1/C(z)”. C(z) in this equation is dynamically presumed by the auxiliary filter (second auxiliary filter) 17.

The auxiliary filter (first auxiliary filter) 16 receives the outputs from the other-seat sound source 11 and the self-seat error microphone 4, and performs a process of presuming the leak sound transfer function P(z) and the error path transfer function C(z). The output of the auxiliary filter 16 is used for adaptive control of the sound-leakage reduction filter 12.

The auxiliary filter (second auxiliary filter) 17 receives the outputs from the virtual sound-source filter 14 and the self-seat error microphone 4, and performs a process of presuming the error path transfer function C(z).

The output of the auxiliary filter (second auxiliary filter) 17 is used for adaptive control of the rear-sound-source inverse filter 15.

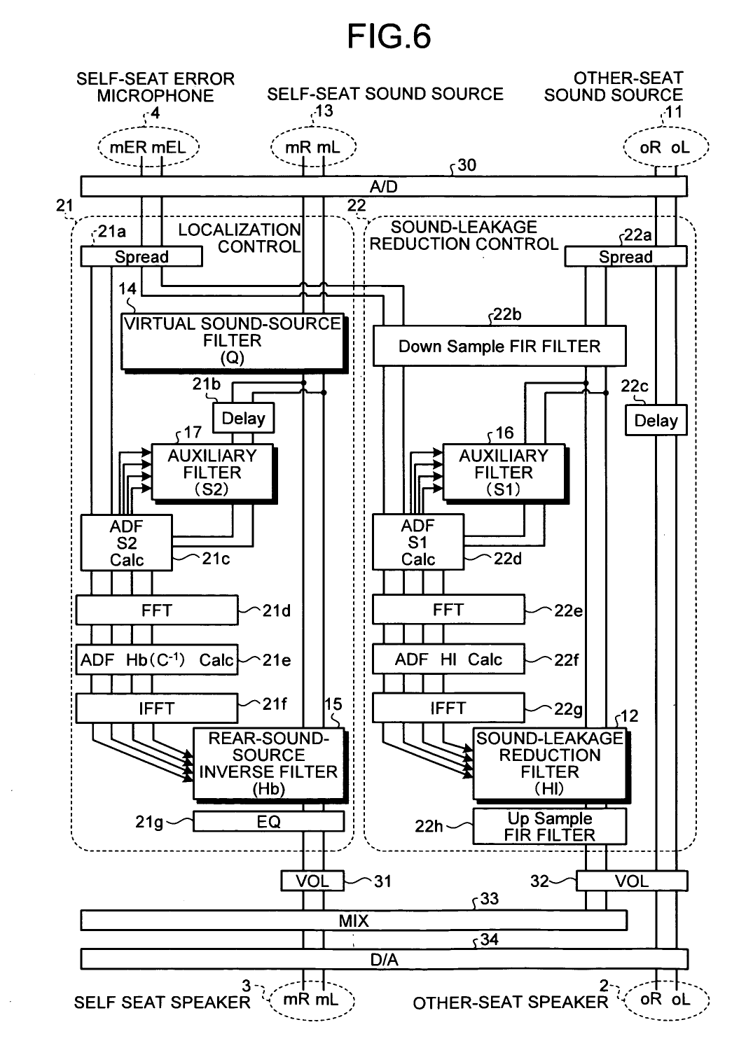

The signal flow in the acoustic system 1 according to the second embodiment is explained next with reference to FIG. 6. FIG. 6 is a signal flow chart of the acoustic system 1 according to the second embodiment. In FIG. 6, “A/D 30” stands for analog-to-digital converter, “Spread 21a” and “Spread 22a” denote signal distributor or duplicator, “EQ 21g” stands for equalizer, “FFT 21d” and “FFT 22e” stand for Fast Fourier Transform, “IFFT 21f” and “IFFT 22g” stand for inverse Fast Fourier Transform, “VOL 31” and “VOL 32” stand for volume, “MIX 33” stands for mixer, and “D/A 34” stands for digital-to-analog converter.

Further, regarding the self-seat error microphone signal corresponding to the self-seat error microphone 4, a signal from the right error microphone 4a is described as “mER” and a signal from the left error microphone 4b is described as “mEL”. Regarding the self-seat sound source 13, the right signal is described as “mR” and the left signal is described as “mL”, and regarding the other-seat sound source 11, the right signal is described as “oR” and the left signal is described as “oL”. Regarding the output signal to the self seat speaker 3, a signal to the right speaker 3a is described as “mR” and a signal to the left speaker 3b is described as “mL”. Regarding the output signal to the other-seat speaker 2, a signal to the right speaker 2a is described as “oR” and a signal to the left speaker 2b is described as “oL”.

As illustrated in FIG. 6, control processing performed by the acoustic system 1 according to the second embodiment can be divided into the localization control 21 mainly performed by the virtual sound-source filter 14, the rear-sound-source inverse filter 15, and the auxiliary filter (second auxiliary filter) 17, and the sound-leakage reduction control 22 mainly performed by the auxiliary filter (first auxiliary filter) 16 and the sound-leakage reduction filter 12.

The signal flow in the localization control 21 is explained first. The signals mR and mL corresponding to the self-seat sound source 13 are input to the virtual sound-source filter 14 via the A/D 30. The virtual sound-source filter 14 converts the signals mR and mL to signals corresponding to the virtual sound field having a virtual sound image in front of the listener on the self seat, and outputs the signals to the rear-sound-source inverse filter 15 and a Delay 21b as a delay device. The rear-sound-source inverse filter 15 performs a correction process of bringing the rearward localization of the sound image closer to the ear position of the listener. On the other hand, the Delay 21b performs a predetermined delay process to the signals mR and mL and output these signals to the auxiliary filter (second auxiliary filter) 17.

The output of the rear-sound-source inverse filter 15 is input to the MIX 33 via the EQ 21a and the VOL 31. The MIX 33 synthesizes the signals mR and mL converted in the localization control 21 with the signals oR and oL converted in the sound-leakage reduction control 22 (control sound, which is a negating sound of the leak sound), and outputs the synthesized signals to the self seat speaker 3 via the D/A 33 as the signals mR and mL.

The signals oR and oL output from the auxiliary filter (second auxiliary filter) 17 are input to an ADF-S2-Calc 21d together with the signals mER and mEL distributed by the Spread 21b and the ADF-S2-Calc 21d calculates a value S2(z) of the auxiliary filter (second auxiliary filter) 17.

A coefficient value group calculated by the ADF-S2-Calc 21d is output to the rear-sound-source inverse filter 15 via the FFT 21d, an ADF-Hb-Calc 21f, and the IFFT 21g. The ADF-Hb-Calc 21f calculates a value Hb(z) of the rear-sound-source inverse filter 15, that is, an inverse function of the error path transfer function C(z).

The signal flow in sound-leakage reduction control 22 is explained next. The signals oR and oL corresponding to the other-seat sound source 11 are input to the Spread 22a via the A/D 30. The Spread 22a distributes the signals oR and oL to the Down Sample FIR filter 22b and the Delay 22c.

The Delay 22c having received the signals oR and oL distributed by the Spread 22a performs a predetermined delay process with respect to these signals, and outputs the signals to the other-seat speaker via the VOL 32 and the D/A 34 as signals oR and oL.

On the other hand, mER and mEL, which are the self-seat error microphone signals via the A/D 30, are also input to the Down Sample FIR filter 22b having received the signals oR and oL distributed by the Spread 22a. The Down Sample FIR filter 22b performs resampling (down-sampling) by using a sampling frequency lower than the sampling frequency of the input signals. The signals down-sampled by the Down Sample FIR filter 22b are up-sampled in the Up Sample FIR filter 22h and output. Thus, by using the down-sampling and the up-sampling together, the leak sound can be reduced highly accurately compared with a case that only the sound in the predetermined frequency range is reduced by using a low-pass filter or the like.

The signals oR and oL output from the Down Sample FIR filter 22b are input to the auxiliary filter (first auxiliary filter) 16 and the sound-leakage reduction filter 12. The signals oR and oL output from the auxiliary filter (first auxiliary filter) 16 are input to an ADF-S1-Calc 22d together with the signals mER and mEL output from the Down Sample FIR filter 22b, thereby calculating a value S1(z) of the auxiliary filter (first auxiliary filter) 16 in the ADF-S1-Calc 22d.

The coefficient value group calculated by the ADF-S1-Calc 22d is output to the sound-leakage reduction filter 12 via the FFT 22e, an ADF-H1-Calc 22f, and the IFFT 22g. The ADF-H1-Calc 22f calculates the value H1(z) of the sound-leakage reduction filter 12.

An output signal from the IFFT 22g and signals oR and oL from the Down Sample FIR filter 22b are input to the sound-leakage reduction filter 12. The control sound (negating sound of the leak sound) calculated by the sound-leakage reduction filter 12 is output to the MIX 33 via the Up Sample FIR filter 22h and the VOL 32, synthesized with the signals mR and mL converted in the localization control 21 by the MIX 33, and output to the self seat speaker 3 via the D/A 34 as the signals mR and mL.

As described above, according to the second embodiment, the acoustic system is configured such that the sound-leakage reduction filter generates a control sound for negating the sound leaked from the other speaker installed in the second individual space toward the first individual space based on the leak sound transfer function between the other speaker and the error microphone and the error path transfer function between the self speaker and the error microphone, by using the self speaker installed at the back of the listener in the first individual space and the error microphone installed closer to the listener than the self speaker, and provides the generated control sound to the self speaker. The virtual sound-source filter generates the virtual sound source, which is a sound provided by arranging a sound image in front of the listener, and the rear-sound-source inverse filter corrects the rearward localization of the sound image generated by reproduction of the virtual sound source by the self speaker closer to the listener. The first auxiliary filter connected to the error microphone and the sound-leakage reduction filter provides the leak sound transfer function and the error path transfer function presumed dynamically to the sound-leakage reduction filter, and the second auxiliary filter connected to the error microphone and the rear-sound-source inverse filter provides the dynamically presumed error path transfer function to the rear-sound-source inverse filter.

Therefore, even if there is an environmental change and a change with time, leak sound from other seats can be effectively reduced, and the sound source can be stably localized frontwise. Further, it is possible to provide an individual acoustic environment with a realistic sense while not blocking the visibility of a listener.

As described above, the acoustic system according to the present invention is useful for providing an individual acoustic environment with respect to each individual space provided in a predetermined space, and particularly suitable for providing an individual acoustic environment in a movable vehicle such as a car.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. An acoustic system comprising:
a self speaker that is installed to be located at back of a listener in a first individual space in a predetermined space;
an error microphone that is installed to be located closer to the listener than the self speaker;
a sound-leakage reducing unit that generates control sound for negating sound leaked from an other speaker installed in a second individual space in the predetermined space to the first individual space based on a leak sound transfer function between the other speaker and the error microphone and an error path transfer function between the self speaker and the error microphone, and provides the control sound to the self speaker;
a virtual sound-source unit that generates a virtual sound source to form a sound image in front of the listener; and
a localization correcting unit that corrects rearward localization of the sound image closer to the listener, the sound image being formed by reproduction of the virtual sound source by the self speaker.

2. The acoustic system according to claim 1, further comprising a first dynamic presuming unit that is connected to the error microphone and the sound-leakage reducing unit, and provides the leak sound transfer function and the error path transfer function presumed dynamically to the sound-leakage reducing unit.

3. The acoustic system according to claim 2, further comprising a second dynamic presuming unit that is connected to the error microphone and the localization correcting unit, and provides the error path transfer function presumed dynamically to the localization correcting unit.

4. The acoustic system according to claim 2, wherein the first dynamic presuming unit is configured as an adaptive filter.

5. The acoustic system according to claim 3, wherein the second dynamic presuming unit is configured as an adaptive filter.

6. The acoustic system according to claim 1, wherein the localization correcting unit is configured as an inverse transfer function of the error path transfer function obtained in advance.

7. The acoustic system according to claim 3, wherein the localization correcting unit is configured as an inverse transfer function of the error path transfer function obtained in advance.

8. The acoustic system according to claim 1, wherein the virtual sound-source unit generates the virtual sound source based on a transfer function obtained in advance.

9. The acoustic system according to claim 3, wherein the virtual sound-source unit generates the virtual sound source based on a transfer function obtained in advance.

10. The acoustic system according to claim 2, further comprising:
a down-sampling unit that down-samples signals from a sound source corresponding to the other speaker and the error microphone and provides the signals to the dynamic presuming unit, the first dynamic unit and the sound-leakage reducing unit; and
an up-sampling unit that up-samples the control sound provided by the sound-leakage reducing unit.

11. The acoustic system according to claim 3, further comprising:
a down-sampling unit that down-samples signals from a sound source corresponding to the other speaker and the error microphone and provides the signals to the second dynamic presuming unit and the sound-leakage reducing unit; and
an up-sampling unit that up-samples the control sound provided by the sound-leakage reducing unit.

12. The acoustic system according to claim 1, wherein the sound-leakage reducing unit generates the control sound for negating sound leaked from other speakers installed respectively in a plurality of second individual spaces to the first individual space.

13. The acoustic system according to claim 3, wherein the sound-leakage reducing unit generates the control sound for negating sound leaked from other speakers installed respectively in a plurality of second individual spaces to the first individual space.

14. The acoustic system according to claim 1, wherein the self speaker is arranged on a backside of a seat in the first individual space to be near head of the listener.

15. The acoustic system according to claim 3, wherein the self speaker is arranged on a backside of a seat in the first individual space to be near head of the listener.

16. The acoustic system according to claim 1, wherein the first individual space and the second individual space each are a space corresponding to any one of seats in a car.

17. The acoustic system according to claim 3, wherein the first individual space and the second individual space each are a space corresponding to any one of seats in a car.

18. The acoustic system according to claim 1, wherein
the first individual space is a space corresponding to a driver's seat in a car, and
the second individual space is a space corresponding to a seat other than the driver's seat in the car.

19. The acoustic system according to claim 3, wherein
the first individual space is a space corresponding to a driver's seat in a car, and
the second individual space is a space corresponding to a seat other than the driver's seat in the car.
